(19) United States
(12) Patent Application Publication
(10) Pub. No.: US 2014/0168944 A1
(43) Pub. Date: Jun. 19, 2014

(54) Socket, Lamp Device and Luminaire

(71) Applicant: TOSHIBA LIGHTING & TECHNOLOGY CORPORATION, Yokosuka-shi, Kanagawa-ken (JP)

(72) Inventors: Takeshi Osada, Yokosuka-shi (JP); Shigeru Osawa, Yokosuka-shi (JP); Yuichiro Takahara, Yokosuka-shi (JP)

(73) Assignee: TOSHIBA LIGHTING & TECHNOLOGY CORPORATION, Yokosuka-shi, Kanagawa-ken (JP)

(21) Appl. No.: 14/235,683

(22) PCT Filed: Jul. 29, 2011
(86) PCT No.: PCT/JP2011/067404

§ 371 Date: Jan. 28, 2014

(51) Int. Cl. F21V 23/06

(52) U.S. Cl. CPC F21V 23/06
USPC 362/95

(57) ABSTRACT

A socket (53) includes a socket body (64) provided with a socket surface (69) to which lamp device is attached. A cylindrical insertion port (68) through which a cap protrusion (36) of the lamp device is inserted is opened in the socket surface (69). A plurality of erroneous mounting preventing keys (71) protruded from positions separated from the socket surface (69) at specified positions of an inner circumferential surface of the insertion port (68). A distance (L2) from the socket surface (69) to the separated position of the erroneous mounting preventing key (71) is smaller than a distance (L1) from a front end surface (38) of the cap protrusion (36) to an attachment key (41). In a state where the front end surface (38) of the cap protrusion (36) contacts the plurality of erroneous mounting preventing keys (71), insertion of the cap protrusion (36) into the insertion port (68) is regulated, and rotation of the cap protrusion (36) in the insertion port (68) in the regulated state is possible. When the cap protrusion (36) rotates to a specified mount position with respect to the socket body (64), an erroneous mounting preventing groove of the cap protrusion (36) is inserted through the erroneous mounting preventing key (71), and the cap protrusion (36) can be inserted to a specified insertion position in the insertion port (68).

### TECHNICAL FIELD

Embodiments of the invention relate to a socket on which a lamp device is mounted, the lamp device mounted on the socket, and a luminaire using the socket and the lamp device.

### BACKGROUND ART

Hitherto, there is a luminaire in which a flat type lamp device using, for example, a GX-type cap and an equipment device including a socket on which the cap of the lamp device is detachably mounted are combined and used.

The lamp device includes a light source and a lighting circuit to light the light source, which are contained in a housing including the cap. Power of specified voltage is supplied to the lamp device from the socket in a state where the cap of the lamp device is mounted on the socket, so that the light source is lit by the lighting circuit of the lamp device.

### CITATION LIST

### Patent Literature

PTL 1: Japanese Laid-open Patent Publication No. 2010-262781

### SUMMARY OF INVENTION

### Technical Problem

In the luminaire as described above, when a plurality of kinds of lamp devices are prepared according to, for example, difference in voltage of power supplied to the lamp device or difference in output of the light source, the respective kinds of lamp devices are combined with suitable kinds of equipment devices and are used. In this case, it is preferable to provide a function to prevent erroneous mounting in which the lamp device is mounted on the socket in unsuitable kind of combination. However, if the function to prevent the erroneous mounting is provided, there is a fear that even in a suitable kind of combination, the mounting property of the lamp device onto the socket becomes liable to be reduced.

The problem to be solved by the invention is to provide a socket having an erroneous mounting preventing function and capable of improving a mounting property of a lamp device, the lamp device mounted on the socket, and a luminaire using the socket and the lamp device.

### Solution to Problem

A socket according to an embodiment is a socket detachably mounted with a lamp device provided with a cap including a cap body, a cylindrical cap protrusion protruding from the cap body, a plurality of erroneous mounting preventing grooves provided at specified positions of a tip peripheral part of the cap protrusion, and an attachment key provided on an outer circumferential surface of the cap protrusion and protruding from a specified position separate from a front end surface of the cap protrusion. The socket includes a socket body provided with a socket surface to which the cap body is attached. A cylindrical insertion port through which the cap protrusion is inserted is opened in the socket surface. Besides, a plurality of erroneous mounting preventing keys is protruded from positions separated from the socket surface at specified positions of an inner circumferential surface of the insertion port. A distance from the socket surface to the separate position of the erroneous mounting preventing key is smaller than a distance from the front end surface of the cap protrusion to the attachment key. In a state where the front end surface of the cap protrusion contacts the plurality of erroneous mounting preventing keys, insertion of the cap protrusion into the insertion port is regulated, and rotation of the cap protrusion in the insertion port is possible in the regulated state. When the cap protrusion is positioned at a specified mount position with respect to the socket body, the erroneous mounting preventing grooves of the cap protrusion are inserted through the erroneous mounting preventing keys, and the cap protrusion can be inserted to a specified insertion position in the insertion port. Besides, an attachment groove is provided on the inner circumferential surface of the insertion port. The attachment key of the cap protrusion inserted to the specified insertion position in the insertion port is inserted in the attachment groove, and the cap is attached to the socket body through the attachment key.

### BRIEF DESCRIPTION OF DRAWINGS

FIG. 1 A partial sectional view of a state where a front end surface of a cap protrusion of a cap of a lamp device contacts an erroneous mounting preventing key of a socket of a first embodiment.

FIG. 2 A perspective view of the socket.

FIG. 3 A front view of the socket.

FIG. 4 A front view of the cap.

FIG. 5 The socket combined with the cap is shown, and (a) is a front view of a state where erroneous mounting preventing grooves of the cap coincide with erroneous mounting preventing keys of the socket, and (b) is a front view of a state where the erroneous mounting preventing grooves of the cap are shifted from the erroneous mounting preventing keys of the socket.

FIG. 6 A sectional view of a luminaire using an equipment device including the socket and a lamp device.

FIG. 7 A perspective view of the luminaire in which the lamp device is detached from the equipment device.

FIG. 8 A front view of a socket of a second embodiment.

FIG. 9 A front view of a socket of a third embodiment.

### DESCRIPTION OF EMBODIMENTS

Hereinafter, an embodiment will be described with reference to the drawings.

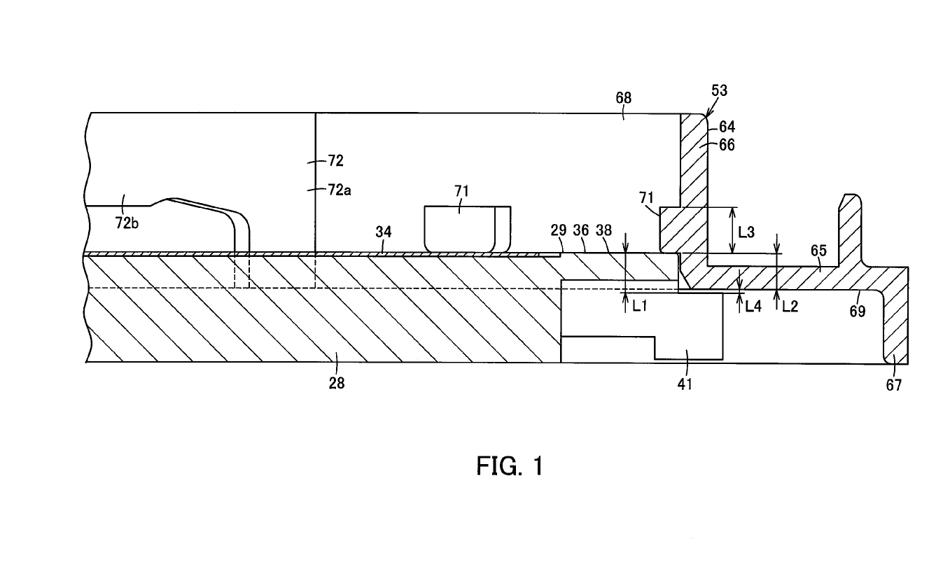

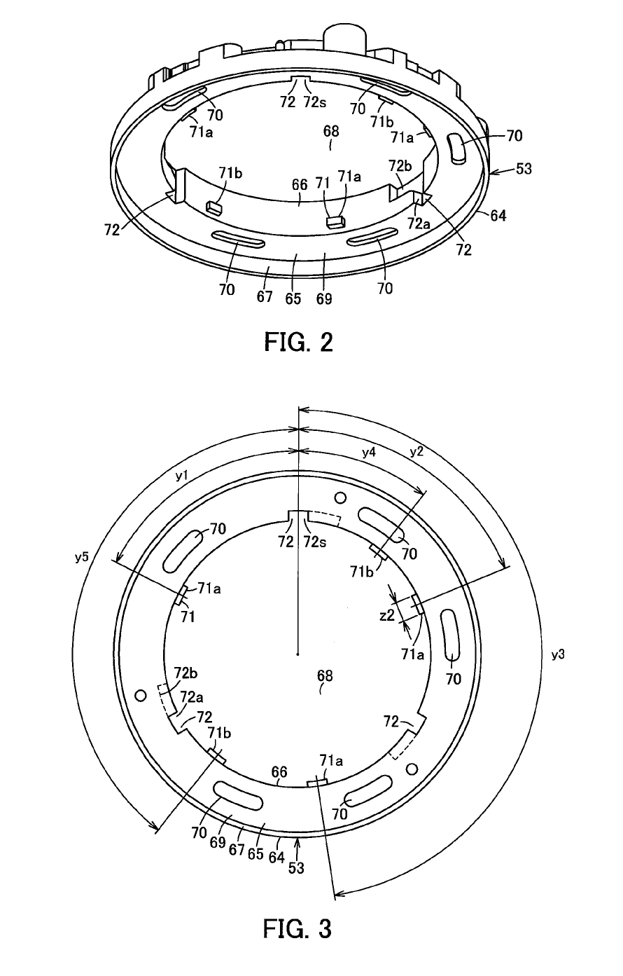

FIG. 1 to FIG. 7 show a first embodiment.

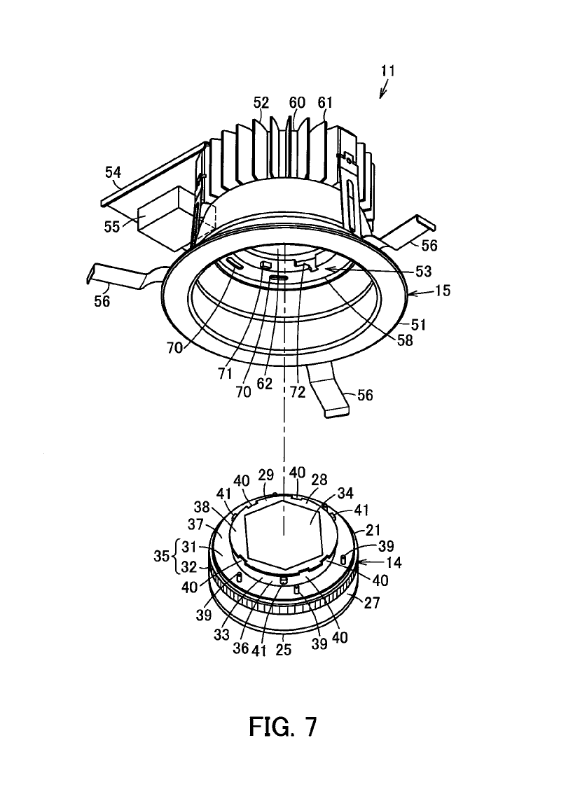

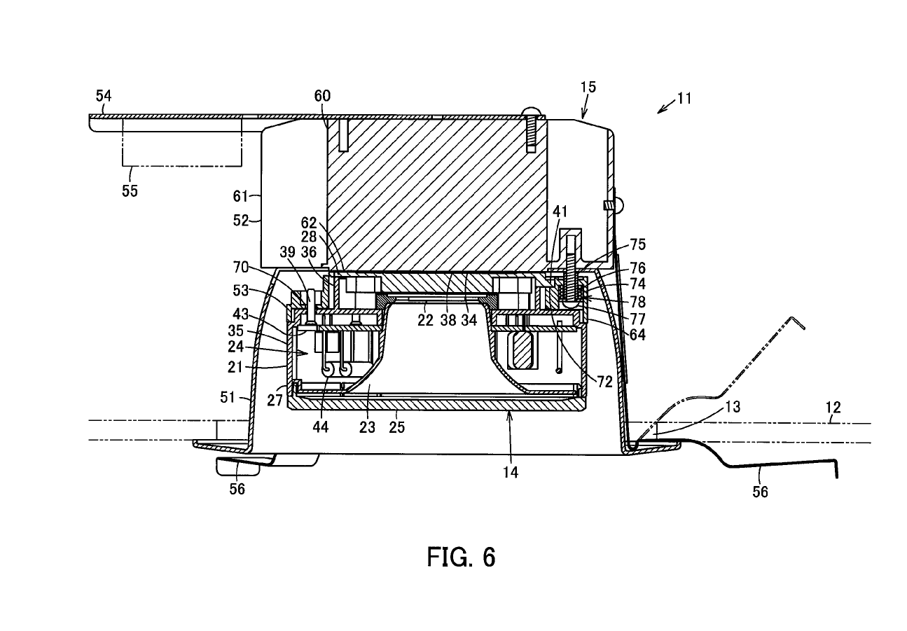

As shown in FIG. 6 and FIG. 7, a luminaire 11 is an embedded-type luminaire such as a downlight and is installed to be embedded in a circular embedding hole 13 provided in a ceiling plate 12. The luminaire 11 includes a flat lamp device 14 and an equipment device 15 on which the lamp device 14 is detachably mounted. Incidentally, hereinafter, an up-and-down direction relation between the lamp device 14 and the equipment device 15 is mentioned on the basis of the installation state of the luminaire 11 to the ceiling plate 12.

There is a plurality of kinds of lamp devices 14 according to the corresponding voltage of input power supply and the output of a light source. Besides, there is a plurality of kinds of equipment devices 15 according to the difference in thermal radiation performance and correspondingly to the kind of the lamp device 14. With respect to the kind of the lamp device 14 according to the corresponding voltage, for example, there is a lamp device for 100V or for 200V, or a voltage-free lamp device corresponding to both 100V and 200V. With respect to the kind of the lamp device 14 according to the output of the light source, for example, there are two kinds of lamp devices for high output and for low output.

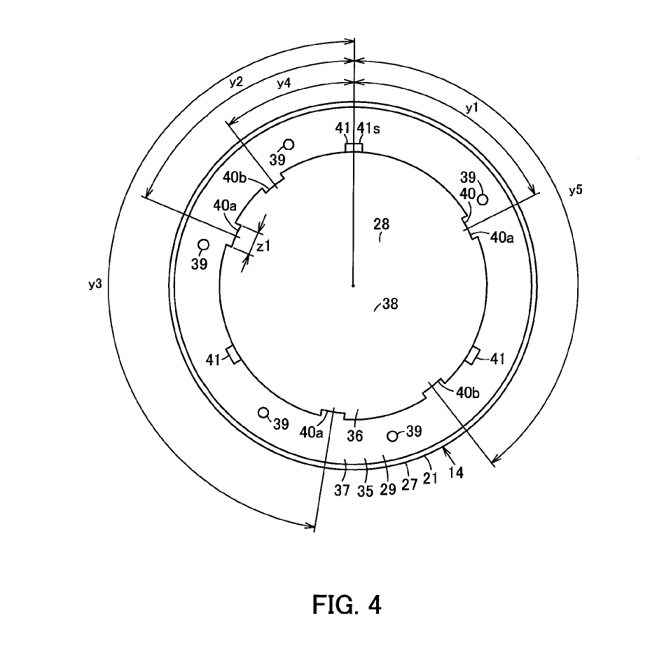

As shown in FIG. 4, FIG. 6 and FIG. 7, the lamp device 14 includes a flat and cylindrical housing 21. A light source 22, a reflector 23 and a lighting circuit 24 are contained in the housing 21, and a transparent cover 25 is attached to a lower surface of the housing 21.

The housing 21 includes a cylindrical case 27 and a disk-shaped shaped cap member 28 attached to an upper surface of the case 27. A cap 29 having a specified standard size is constructed of the upper side of the case 27 and the cap member 28.

The case 27 is made of a synthetic resin having an insulation property, and includes an upper surface end plate part 31, a cylindrical circumferential surface part 32 protruding downward from the peripheral part of the end plate part 31, and a cylindrical tube part 33 protruding upward from the upper surface of the end plate part 31. The lower surface of the case 27 is opened.

The cap member 28 is made of, for example, a metal material such as aluminum die-cast and is formed into a disk shape. The diameter of the cap member 28 is larger than the diameter of the tube part 33 of the case 27, and the peripheral part of the cap member 28 protrudes from the outer circumferential surface of the tube part 33 of the case 27. A heat conductive sheet 34 is mounted on the upper surface of the cap member 28.

The end plate part 31, the circumferential surface part 32 and the like of the case 27 are constructed as a cap body 35. The tube part 33 of the case 27 and the cap member 28 are constructed as a cylindrical cap protrusion 36 protruding from the cap body 35. Further, the upper surface of the end plate part 31 of the case 27 is constructed as a cap surface 37, and the upper surface of the cap member 28 is constructed as a front end surface 38 of the cap protrusion 36.

A plurality of lamp pins 39 are provided to protrude from the cap surface 37 of the cap body 35. In this embodiment, the five lamp pins 39 are provided, in which two lamp pins 39 are for power supply input, two lamp pins 39 are for dimming signal input, and one lamp pin 39 is for earth connection. Incidentally, if the lamp pins 39 for power supply input are provided, the lamp pins 39 for dimming signal input and for earth connection may not be provided.

A plurality of erroneous mounting preventing grooves 40 is cut and formed in the peripheral part of the cap member 28. A plurality of attachment keys 41 is protrudingly formed and is respectively positioned between the erroneous mounting preventing grooves 40 adjacent to each other in the circumferential direction.

As shown in FIG. 4, in this embodiment, the three attachment keys 41 are provided at positions of equal intervals of 120° in the circumferential direction of the cap member 28. One of the three attachment keys is a reference attachment key 41s. As shown in FIG. 1, the attachment key 41 protrudes from a position separate by a specified distance L1 from the upper surface of the cap member 28, that is, the front end surface 38 to the cap body 35 side, toward the outer diameter direction with respect to the peripheral part of the cap member 28.

Further, as shown in FIG. 4, among the plurality of erroneous mounting preventing grooves 40, three of them are erroneous mounting preventing grooves 40a for voltage differentiation to prevent erroneous mounting when the corresponding voltage of the lamp device 14 is wrong, and two of them are erroneous mounting preventing grooves 40b for output differentiation corresponding to the difference in the output of the lamp device 14.

The three erroneous mounting preventing grooves 40a for voltage differentiation are formed at positions separate by specified angles y1, y2 and y3 in the circumferential direction of the cap member 28 with respect to the reference attachment key 41s as a reference, and the angles y1, y2 and y3 are determined according to the corresponding voltage of the lamp device 14. For example, with respect to the erroneous mounting preventing groove 40a of the lamp device 14 for 100V and the erroneous mounting preventing groove 40a of the lamp device 14 for 200V, the angles y1, y2 and y3 from the reference attachment key 41s are relatively shifted. Besides, a width size z1 of the erroneous mounting preventing groove 40a in the circumferential direction is a common width size for 100V and 200V, or is a special width size for each of them. Further, in the case of the voltage-free lamp device 14 corresponding to both 100V and 200V, the width size is so wide that the erroneous mounting preventing groove 40a is continuous from the position of the erroneous mounting preventing groove 40a for 100V to the position of the erroneous mounting preventing groove 40a for 200V.

The two erroneous mounting preventing grooves 40b for output differentiation are positioned at symmetrical positions with respect to the center of the cap member 28, and are provided at the positions separate by specified angles y4 and y5 from the reference attachment key 41s. The angles y4 and y5 may be provided at common positions irrespective of the corresponding voltage of the lamp device 14, or may be provided at positions relatively shifted according to the corresponding voltage of the lamp device 14. Incidentally, the erroneous mounting preventing groove 40b for output differentiation is provided in the case of the lamp device 14 for low output, and is not provided in the case of the lamp device 14 for high output.

Besides, as shown in FIG. 6, the light source 22 is closely attached to the lower surface of the cap member 28. As the light source 22, for example, a semiconductor light-emitting element such as an LED element or an EL element is used. In this embodiment, the LED element is used as the semiconductor light-emitting element, and a COB (Chip On Board) system in which a plurality of LED elements is mounted on a substrate is adopted. Incidentally, a system may be used in which a plurality of SMD (Surface Mount Device) packages each mounted with LED elements and having a connection terminal are mounted on a substrate.

The reflector 23 is made of, for example, a synthetic resin having an insulation property, and is formed into a cylindrical shape expanding downward.

The lighting circuit 24 includes, for example, a circuit to rectify and smooth a commercial power supply voltage, a DC/DC converter including a switching element to switch at a high frequency of several kHz to several hundred kHz, and the like, and constitutes a power supply circuit to light the LED elements. The lighting circuit 24 includes a circuit board 43 and a plurality of lighting circuit parts 44 mounted on the circuit board 43.

Next, as shown in FIG. 6 and FIG. 7, the equipment device 15 includes a reflector 51 opening downward, a thermal radiator 52 as an equipment body attached to an upper part of the reflector 51, a socket 53 attached to a lower part of the thermal radiator 52, a terminal stand 55 attached to an upper part of the thermal radiator 52 by an attachment plate 54, and a plurality of attachment springs 56 for ceiling attachment attached to the periphery of the thermal radiator 52.

A circular opening 58 in which the lower surface of the thermal radiator 52 is exposed is formed in the top of the reflector 51.

The thermal radiator 52 is formed of a material excellent in thermal radiation property, for example, a metal such as aluminum die-cast or ceramic. The thermal radiator 52 includes a columnar base part 60, and a plurality of thermal radiation fins 61 radially protruding from the periphery of the base part 60. A flat contact surface 62 exposed through the opening 58 of the reflector 51 is formed on a lower surface of the base part 60.

Besides, as shown in FIG. 1 to FIG. 3, the socket 53 includes a socket body 64 made of a synthetic resin having an insulation property and formed into a circular shape, and a plurality of not-shown terminals disposed in the socket body 64.

The socket body 64 includes an annular socket part 65, a cylindrical guide part 66 protruding upward from the inner peripheral part of the socket part 65, and a cylindrical edge part 67 protruding downward from the peripheral part of the socket part 65. A circular insertion port 68 through which the cap protrusion 36 of the lamp device 14 is inserted is formed inside the guide part 66. An inner diameter of the insertion port 68 is slightly larger than a diameter of the cap member 28 and is smaller than a diameter of a virtual circle passing through a front end surface of the attachment key 41 of the cap member 28.

A socket surface 69 to which the cap body 35 of the lamp device 14 is attached is formed on the lower surface of the socket part 65. A plurality of connection holes 70 in which the plurality of lamp pins 39 of the lamp device 14 is inserted is formed into a long hole shape in the socket part 65 along the circumferential direction of the socket part 65. The respective terminals are disposed at upper sides of the respective connection holes 70, and the respective lamp pins 39 of the lamp device 14 inserted in the respective connection holes 70 are electrically connected to the respective terminals.

A plurality of erroneous mounting preventing keys 71 is protrudingly formed on the inner circumferential surface of the guide part 66, and a plurality of attachment grooves 72 is formed.

As shown in FIG. 3, in this embodiment, the three attachment grooves 72 are provided at positions of equal intervals of 120° in the circumferential direction of the guide part 66, and are provided between the erroneous mounting preventing keys 71 adjacent to each other in the circumferential direction. One of the three attachment grooves is a reference attachment groove 72s. The attachment groove 72 is formed into a substantially L shape including a vertical groove 72a formed along the up-and-down direction and a lateral groove 72b formed along the circumferential direction at the upper side of the guide part 66. The attachment grooves 72 of the socket 53 and the attachment keys 41 of the lamp device 14 constitute an attachment and detachment structure in which mounting is performed by inserting and rotating the attachment keys 41 of the lamp device 14 in the attachment grooves 72 of the socket 53, and from the mounted state, detaching is performed by rotating and pulling out the attachment keys 41 of the lamp device 14 from the attachment grooves 72 of the socket 53.

Further, three of the plurality of erroneous mounting preventing keys 71 is erroneous mounting preventing keys 71a for voltage differentiation to prevent erroneous mounting when the corresponding voltage of the lamp device 14 is wrong, and two of them are erroneous mounting preventing keys 71b for output differentiation corresponding to the difference in the output of the lamp device 14. The erroneous mounting preventing keys 71 are protruded into the insertion port 68 from positions separated from the socket surface 69 by a specified distance L2.

The three erroneous mounting preventing keys 71a for voltage differentiation are formed at positions separated from the reference attachment groove 72s by specified angles y1, y2 and y3 in the circumferential direction of the socket 53. The angles y1, y2 and y3 are determined according to the corresponding voltage of the lamp device 14. For example, with respect to the erroneous mounting preventing key 71a of the socket 53 on which the lamp device 14 for 100V is mounted and the erroneous mounting preventing key 71a of the socket 53 on which the lamp device 14 for 200V is mounted, the angles y1, y2 and y3 from the reference attachment groove 72s are relatively shifted. Besides, width sizes z2 of the erroneous mounting preventing keys 71a in the circumferential direction are a common width size for 100V and 200V or are respectively special width sizes.

The two erroneous mounting preventing keys 71b for output differentiation are positioned at symmetrical positions with respect to the center of the socket 53, and are provided at positions separated from the reference attachment groove 72s by specified angles y4 and y5. The angles y4 and y5 may be provided at common positions irrespective of the corresponding voltage of the lamp device 14 or may be provided at positions relatively shifted according to the corresponding voltage of the lamp device 14. Incidentally, the erroneous mounting preventing key 71b for output differentiation is provided for the socket 53 on which the lamp device 14 for low output is mounted, and is not provided for the socket 53 on which the lamp device 14 for high output is mounted.

Besides, as shown in FIG. 1, the distance L2 from the socket surface 69 to the erroneous mounting preventing key 71 is smaller than the distance L1 from the front end surface 38 of the cap protrusion 36 to the attachment key 41. In the state where the front end surface 38 of the cap protrusion 36 contacts the erroneous mounting preventing key 71, insertion of the cap protrusion 36 into the insertion port 68 is regulated, and rotation of the cap protrusion 36 in the insertion port 68 is possible in the regulated state.

Further, a size L3 of the erroneous mounting preventing key 71 in the up-and-down direction corresponding to the axial direction of the insertion port 68 of the socket 53 is larger than a distance L4 from the socket surface 69 to the attachment key 41 in the state where the front end surface 38 of the cap protrusion 36 contacts the erroneous mounting preventing key 71.

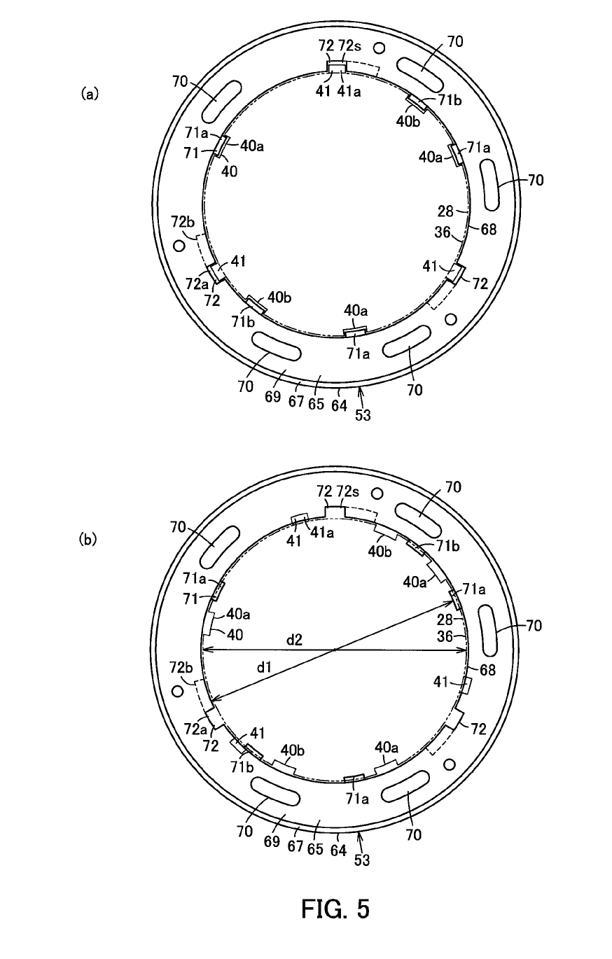

Further, as shown in FIG. 5(b), a maximum distance d1 between the front end surface of each of the erroneous mounting preventing keys 71 of the socket 53 and the insertion port 68 is smaller than a diameter d2 of the cap member.

As shown in FIG. 6, a plurality of bosses 74 opening to the socket surface 69 is formed on the socket body 64. A sleeve 75 passing through the boss 74 and contacting the reflector 51, a coil spring 76 as an elastic body disposed at the outer periphery of the sleeve 75, and a screw 77 passing through the sleeve 75 and the reflector 51 and screwed to the thermal radiator 52 are disposed in the boss 74. The sleeve 75 and the reflector 51 are integrally sandwiched and fixed by tightening of the screw 77 relative to the thermal radiator 52. The coil spring 76 is disposed in a compressed state between a depth side surface of the boss 74 and a head part of the screw 77, and has a repulsive force in the direction of pressing the socket 53 to the thermal radiator 52.

The socket body 64 is supported by the sleeve 75 movably in the up-and-down direction perpendicular to the contact surface 62 of the thermal radiator 52, and is pressed upward to the thermal radiator 52 by the repulsive force of the coil spring 76. A support mechanism 78 is constructed in which the cap 29 of the lamp device 14 is mounted on the socket 53 by the socket body 64, the sleeve 75, the coil spring 76, the screw 77 and the like, so that the front end surface 38 of the cap protrusion 36 is pressed to the contact surface 62 through the heat conductive sheet 34.

The terminal stand 55 is electrically connected to the terminals of the socket 53.

With respect to the luminaire 11 constructed by the lamp device 14 and the equipment device 15, when the plurality of kinds of lamp devices 14 is prepared according to the difference in the corresponding voltage of the lamp device 14 and the difference in the output of the light source 22, and the plurality of suitable kinds of equipment devices 15 is prepared for the respective kinds of the lamp devices 14 according to the difference in thermal radiation performance or the like, the suitable kind of lamp device 14 and equipment device 15 are combined.

This is for causing, for example, the lamp device 14 for 100V to be combined with the equipment device 15 for only 100V, and the lamp device 14 for 200V to be combined with the equipment device 15 for only 200V.

Further, this is for preventing the lamp device 14 of the kind in which the output of the light source 22 is large from being mounted on the equipment device 15 suitable for the lamp device 14 of the kind in which the output of the light source 22 is small. That is, when the thermal radiation performance of the equipment device 15 is optimized according to the output of the light source 22 of the lamp device 14, if the lamp device 14 including the high output light source 22 is mounted on the equipment device 15 suitable for the lamp device 14 including the low output light source 22, there is a fear that desired performance of the lamp device 14 can not be achieved. On the other hand, even if the lamp device 14 including the low output light source 22 is mounted on the equipment device 15 suitable for the lamp device 14 including the high output light source 22, the thermal radiation performance is merely excessive, and desired performance can be achieved. That is, the lamp device 14 is desirably constructed such that the lamp device 14 can be mounted on the equipment device 15 suitable for a lamp device 14 having a larger output than its own light source 22, and can not be mounted on the equipment device 15 suitable for a lamp device 14 having a smaller output than its own light source 22.

As described above, the suitable combination of the lamp device 14 and the equipment device 15 is desirably set according to the difference in the corresponding voltage of the lamp device 14 and the difference in the output of the light source 22. Besides, the suitable combination of the lamp device 14 and the equipment device 15 can be set by changing the positions and the presence or absence of the erroneous mounting preventing grooves 40 of the cap 29 and the erroneous mounting preventing keys 71 of the socket 53 according to the kind.

Next, mounting of the lamp device 14 onto the equipment device 15 will be described.

First, the lamp device 14 is inserted from the lower surface opening of the equipment device 15, and the cap protrusion 36 of the lamp device 14 is inserted in the insertion port 68 of the socket 53.

At this time, as shown in FIG. 5(b), if the positions of the plurality of erroneous mounting preventing grooves 40 of the cap protrusion 36 and the plurality of erroneous mounting preventing keys 71 protruding in the insertion port 68 are shifted, the front end surface 38 of the cap protrusion 36 contacts the plurality of erroneous mounting preventing keys 71 and the insertion is regulated.

In the state where the front end surface 38 of the cap protrusion 36 contacts the plurality of erroneous mounting preventing keys 71, the cap protrusion 36 can be rotated so that the positions of the plurality of erroneous mounting preventing grooves 40 of the cap protrusion 36 and the plurality of erroneous mounting preventing keys 71 of the socket 53 coincide with each other.

At this time, as shown in FIG. 1, the distance L2 from the socket surface 69 to the erroneous mounting preventing key 71 is smaller than the distance L1 from the front end surface 38 of the cap protrusion 36 to the attachment key 41. Accordingly, even if the front end surface 38 of the cap protrusion 36 is somewhat obliquely inserted in the socket 53, it does not occur that the attachment key 41 protruding from the circumferential surface part of the cap protrusion 36 is caught by the attachment groove 72 of the socket 53 and the rotation of the cap protrusion 36 is obstructed. Thus, the cap protrusion 36 can be stably rotated.

Further, the maximum distance d1 between the front end surface of each of the erroneous mounting preventing keys 71 of the socket 53 and the insertion port 68 is smaller than the diameter d2 of the cap protrusion 36. Accordingly, even if the cap protrusion 36 is shifted in a diameter direction in the insertion port 68, it does not occur that the front end surface 38 of the cap protrusion 36 comes out of the erroneous mounting preventing key 71 and is inclined. Thus, the state in which the front end surface 38 of the cap protrusion 36 contacts the plurality of erroneous mounting preventing keys 71 can be held, and the cap protrusion 36 can be stably rotated.

Here, in the case of the suitable combination of the lamp device 14 and the equipment device 15, when the cap protrusion 36 in which the end portion of the insertion port 68 of the socket 53 is inserted is rotated, as shown in FIG. 5(a), all the positions of the plurality of erroneous mounting preventing grooves 40 of the cap protrusion 36 and the plurality of erroneous mounting preventing keys 71 protruding in the insertion port 68 coincide with each other. By this, the plurality of erroneous mounting preventing grooves 40 of the cap protrusion 36 are fitted in the plurality of erroneous mounting preventing keys 71 protruding in the insertion port 68, and the cap protrusion 36 can be inserted into the insertion port 68.

At this time, as shown in FIG. 1, the distance L2 from the socket surface 69 to the erroneous mounting preventing key 71 is smaller than the distance L1 from the front end surface 38 of the cap protrusion 36 to the attachment key 41. Thus, in the state where the front end surface 38 contacts the erroneous mounting preventing key 71, the attachment key 41 does not contact the socket surface 69. That is, even if the lamp device 14 is rotated in the state where the front end surface 38 contacts the erroneous mounting preventing key 71, the rotation operation can be smoothly performed because the attachment key 41 does not interfere with the socket surface 69. The lamp device 14 can be inserted in the axial direction of the insertion port 68 at the positions where the plurality of erroneous mounting preventing grooves 40 of the cap protrusion 36 are fitted in the plurality of erroneous mounting preventing keys 71 protruding in the insertion port 68. In the state where the plurality of erroneous mounting preventing grooves 40 are fitted in the plurality of erroneous mounting preventing keys 71 protruding in the insertion port 68, a state occurs in which the position of the cap protrusion 36 with respect to the socket 53 in the circumferential direction is positioned. At this time, since the plurality of erroneous mounting preventing grooves 40 and the plurality of erroneous mounting preventing keys 71 are respectively provided at one-rotation symmetrical positions, the positions of the lamp device 14 and the socket 53 are positioned at one place. The plurality of attachment keys 41 can be positioned and inserted in the plurality of attachment grooves 72 in the state where the positions of the lamp device 14 and the socket 53 are positioned. Further, the size L3 of the erroneous mounting preventing key 71 in the up-and-down direction corresponding to the axial direction of the insertion port 68 is larger than the distance L4 from the socket surface 69 to the attachment key 41 in the state where the front end surface 38 of the cap protrusion 36 contacts the erroneous mounting preventing key 71. Accordingly, the plurality of attachment keys 41 can be respectively positioned and inserted in the plurality of attachment grooves of the socket 53 in the state where the plurality of erroneous mounting preventing grooves 40 of the cap protrusion 36 are fitted in the plurality of erroneous mounting preventing keys 71 protruding in the insertion port 68, and the position of the cap protrusion 36 with respect to the socket 53 in the circumferential direction is positioned.

Then, the cap protrusion 36 is inserted into the insertion port 68 till the insertion position where the front end surface (heat conductive sheet 34) of the cap protrusion 36 contacts the contact surface 62 of the thermal radiator 52. At this time, the lamp pins 39 protruding from the cap 29 are inserted in the respective connection holes 70 of the socket 53.

The lamp device 14 inserted in the socket 53 till the specified position is rotated in the mount direction by a specified angle, so that the respective attachment keys 41 of the cap protrusion 36 enter the lateral grooves 72b of the attachment grooves 72 of the socket 53 and are caught, and the lamp device 14 is attached to the socket 53. At this time, the respective lamp pins 39 of the cap 29 move in the respective connection holes 70 of the socket 53, contact the respective terminals disposed in the respective connection holes 70 and are electrically connected.

When the attachment key 41 of the cap protrusion 36 enters the lateral groove 72b of the attachment groove 72 of the socket 53, the socket body 64 is pressed down against the coil spring 76 by the attachment key 41 of the cap 29. By this, the repulsive force of the coil spring 76 is exerted in the direction of pressing the cap 29 to the contact surface 62 of the thermal radiator 52 through the socket body 64, and the front end surface 38 of the cap protrusion 36 is pressed to the contact surface 62 of the thermal radiator 52 through the heat conductive sheet 34. Accordingly, in the state where the cap 29 of the lamp device 14 is mounted on the socket 53, the front end surface 38 of the cap protrusion 36 is in close contact with the contact surface 62 of the thermal radiator 52 through the heat conductive sheet 34, and heat can be efficiently conducted from the cap 29 of the lamp device 14 to the thermal radiator 52.

On the other hand, in the case of the unsuitable combination of the lamp device 14 and the equipment device 15, even if the cap protrusion 36 in which the end portion of the insertion port 68 of the socket 53 is inserted is rotated, all the positions of the plurality of erroneous mounting preventing grooves 40 of the cap protrusion 36 and the plurality of erroneous mounting preventing keys 71 protruding in the insertion port 68 do not coincide with each other.

Also at this time, as shown in FIG. 1, the distance L2 from the socket surface 69 to the erroneous mounting preventing key 71 is smaller than the distance L1 from the front end surface 38 of the cap protrusion 36 to the attachment key 41. Accordingly, even if the front end surface 38 of the cap protrusion 36 is inserted somewhat obliquely in the socket 53, it does not occur that the attachment key 41 protruding from the circumferential surface part of the cap protrusion 36 is caught by the attachment groove 72 of the socket 53 and the rotation of the cap protrusion 36 is obstructed.

Accordingly, the front end surface 38 of the cap protrusion 36 contacts the plurality of erroneous mounting preventing keys 71 and the insertion remains regulated. The cap protrusion 36 can not be inserted till the specified insertion position in the insertion port 68 of the socket 53. Therefore, the unsuitable combination of the lamp device 14 and the equipment device 15 can be prevented.

Since the plurality of attachment keys 41 of the lamp device 14 and the attachment grooves 72 of the socket are for supporting the lamp device 14 to the socket 53, providing them at rotation symmetrical positions of the lamp device 14 and the socket 53 is preferable since the lamp device 14 can be stably supported to the socket 53.

However, if the attachment keys 41 and the attachment grooves 72 are provided at the rotation symmetrical positions of the lamp device 14 and the socket 53, the lamp device 14 can be inserted into the socket 53 at plurality of positions during one rotation of the lamp device 14. Besides, if the attachment keys 41 and the attachment grooves 72 are made to have also the erroneous mounting preventing function, the attachment keys 41 and the attachment grooves 72 are provided at asymmetrical positions of the lamp device 14 and the socket 53. Thus, this is not preferable in stably supporting the lamp device 14 to the socket 53.

Then, in this embodiment, the lamp device 14 is provided with the erroneous mounting preventing grooves 40, and the socket 53 is provided with the erroneous mounting preventing keys 71. The position where the erroneous mounting preventing grooves 40 and the erroneous mounting preventing keys 71 can be fitted to each other is made one place during one rotation of the lamp device 14.

By this, in the state where the front end surface 38 of the cap protrusion 36 of the lamp device 14 contacts the erroneous mounting preventing key 71, and the erroneous mounting preventing grooves 40 and the erroneous mounting preventing keys 71 are aligned by rotating the lamp device 14, the attachment keys 41 and the attachment grooves 72 are automatically aligned.

Accordingly, the lamp device 14 and the socket 53 are aligned in the rotation direction by fitting between the erroneous mounting preventing key 71 and the erroneous mounting preventing groove 40, and further, the lamp device 14 is stably supported to the socket 53 by fitting between the attachment key 41 and the attachment groove 72.

As described above, in this embodiment, the function of aligning the lamp device 14 and the socket 53 and the function of supporting the lamp device 14 are respective realized by the different structures. Further, in the state where the front end surface 38 of the cap protrusion 36 of the lamp device 14 contacts the erroneous mounting preventing keys 71 of the socket 53, the attachment keys 41 of the lamp device 14 having the lamp support function do not interfere with the socket 53. Thus, the erroneous mounting of the lamp device 14 can be prevented, and the mounting property of the lamp device 14 can be improved.

Besides, when the lamp device 14 mounted on the equipment device 15 is detached, first, the lamp device 14 is rotated in the detachment direction opposite to the direction at the mounting time, so that the respective attachment keys 41 of the cap 29 move from the lateral grooves 72b of the respective attachment grooves 72 of the socket 53 to the vertical grooves 72a. Subsequently, the lamp device 14 is moved downward, so that the respective lamp pins 39 are detached from the respective connection holes 70 of the socket 53. Besides, in the state where the respective attachment keys 41 of the cap 29 are in the vertical grooves 72a of the respective attachment grooves 72 of the socket 53, the respective erroneous mounting preventing grooves 40 of the cap 29 pass through the respective erroneous mounting preventing keys 71 of the socket 53. Thereafter, the respective attachment keys 41 of the cap 29 are detached from the respective attachment grooves 72 of the socket 53. Further, the cap protrusion 36 is detached from the insertion port 68 of the socket 53, and the lamp device 14 can be detached from the socket 53.

Next, lighting of the lamp device 14 will be described.

When power of specified voltage is supplied to the lighting circuit 24 through the terminals of the socket 53 and the lamp pins 39 of the lamp device 14, lighting power is supplied from the lighting circuit 24 to the semiconductor light-emitting element of the light source 22, and the semiconductor light-emitting element is lit. The light emitted from the light source 22 by the lighting of the semiconductor light-emitting element passes in the reflector 23, and further is transmitted through the transparent cover 25 and is emitted from the lower surface opening of the equipment device 15.

Besides, heat generated by the semiconductor light-emitting element of the light source 22 at the time of lighting is mainly efficiently conducted to the cap member 28 to which the light source 22 is attached, is efficiently conducted from the cap member 28 through the heat conductive sheet 34 to the closely-contacted thermal radiator 52, and is radiated to the air from the surface of the thermal radiator 52 including the plurality of thermal radiation fins 61.

As described above, in the socket 53 of this embodiment, the distance L2 from the socket surface 69 to the erroneous mounting preventing key 71 is smaller than the distance L1 from the front end surface 38 of the cap protrusion 36 to the attachment key 41. Thus, when the cap 29 of the lamp device 14 is mounted on the socket 53, in the state where the front end surface 38 of the cap protrusion 36 contacts the plurality of erroneous mounting preventing keys 71, when the cap protrusion 36 is rotated so that the plurality of erroneous mounting preventing grooves 40 of the cap protrusion 36 coincide with the positions of the plurality of erroneous mounting preventing keys 71 of the socket 53, the attachment keys 41 are prevented from being caught by the attachment grooves 72 of the socket 53 and from obstructing the rotation of the cap protrusion 36. Thus, the cap protrusion 36 can be stably rotated. Besides, even if the front end surface 38 of the cap protrusion 36 is somewhat obliquely inserted in the socket 53, the attachment key 41 protruding from the circumferential surface part of the cap protrusion 36 can be suppressed from being caught by the attachment groove 72 of the socket 53. Accordingly, the socket 53 can be provided which has the erroneous mounting preventing function and can improve the mounting property of the lamp device 14.

Further, when the plurality of erroneous mounting preventing grooves 40 of the cap protrusion 36 coincide with the positions of the plurality of erroneous mounting preventing keys 71 of the socket 53, and the cap protrusion 36 is inserted into the insertion port 68 of the socket 53, first, the plurality of erroneous mounting preventing grooves 40 of the cap protrusion 36 is fitted in the plurality of erroneous mounting preventing keys 71 of the socket 53, and the state occurs in which the position of the cap protrusion 36 with respect to the socket 53 in the circumferential direction is positioned. Thus, thereafter, the plurality of attachment keys 41 of the cap 29 can be positioned and inserted in the plurality of attachment grooves 72 of the socket 53. Accordingly, the socket 53 can be provided which has the erroneous mounting preventing function and can improve the mounting property of the lamp device 14.

Further, the attachment grooves 72 are provided between the plurality of erroneous mounting preventing keys 71 on the inner circumferential surface of the insertion port 68 of the socket 53. Thus, the plurality of attachment keys 41 can be respectively positioned and inserted in the plurality of attachment grooves of the socket 53 in the state where the plurality of erroneous mounting preventing grooves 40 of the cap protrusion 36 are respectively fitted in the plurality of erroneous mounting preventing keys 71 of the socket 53, and the position of the cap protrusion 36 with respect to the socket 53 in the circumferential direction is positioned.

Besides, the size L3 of the erroneous mounting preventing key 71 in the up-and-down direction corresponding to the axial direction of the insertion port 68 is larger than the distance L4 from the socket surface 69 to the attachment key 41 in the state where the front end surface 38 of the cap protrusion 36 contacts the erroneous mounting preventing key 71. Thus, the plurality of attachment keys 41 can be respectively positioned and inserted in the plurality of attachment grooves of the socket 53 in the state where the plurality of erroneous mounting preventing grooves 40 of the cap protrusion 36 is respectively fitted in the plurality of erroneous mounting preventing keys 71 protruding in the insertion port 68, and the position of the cap protrusion 36 with respect to the socket 53 in the circumferential direction is positioned.

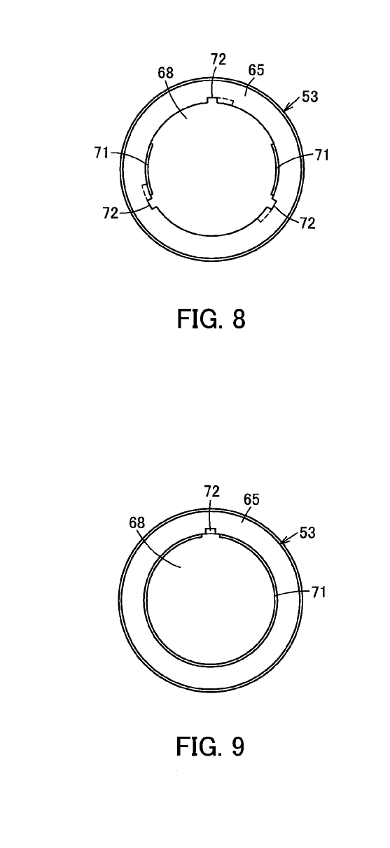

Besides, as in a second embodiment shown in FIG. 8, the number of erroneous mounting preventing keys 71 of the socket 53 may be two. In this case, the two erroneous mounting preventing keys 71 are provided to be wide along the circumferential direction and at symmetrical positions with respect to the center of the socket 53. Thus, in the state where the front end surface 38 of the cap protrusion 36 contacts the two erroneous mounting preventing keys 71, the cap protrusion 36 can be held horizontally and can be stably rotated.

Besides, as in a third embodiment shown in FIG. 9, the socket 53 may include one erroneous mounting preventing key 71. In this case, one attachment groove 72 is provided, and the one erroneous mounting preventing key 71 is provided in most regions in the circumferential direction except for the one attachment groove 72. Consequently, in the state where the front end surface 38 of the cap protrusion 36 contacts the one erroneous mounting preventing key 71, the cap protrusion 36 can be held horizontally and can be stably rotated.

Incidentally, in this case, since the one attachment groove 72 is provided, the cap 29 is also provided with one attachment key 41. However, the cap 29 can be attached to the socket 53 even by the one attachment groove 72 and the one attachment key 41.

While certain embodiments have been described, these embodiments have been presented by way of example only, and are not intended to limit the scope of the inventions. Indeed, the novel embodiments described herein may be embodied in a variety of other forms; furthermore, various omissions, substitutions, and changes in the form of the embodiments described herein may be made without departing from the spirit of the inventions. The accompanying claims and their equivalents are intended to cover such forms or modifications as would fall within the scope and spirit of the inventions.

### REFERENCE SIGNS LIST

11 luminaire
14 lamp device
15 equipment device
21 housing
22 light source
24 lighting circuit
29 cap
35 cap body
36 cap protrusion
38 front end surface
40 erroneous mounting preventing groove
41 attachment key
53 socket
64 socket body
68 insertion port
69 socket surface
71 erroneous mounting preventing key
72 attachment groove

1. A socket detachably mounted with a lamp device provided with a cap including a cap body, a cylindrical cap protrusion protruding from the cap body, a plurality of erroneous mounting preventing grooves provided at specified positions of a tip peripheral part of the cap protrusion, and an attachment key provided on an outer circumferential surface of the cap protrusion and protruding from a specified position separate from a front end surface of the cap protrusion, comprising:
a socket body including a socket surface to which the cap body is attached;
a cylindrical insertion port which is opened in the socket surface and through which the cap protrusion is inserted;
a plurality of erroneous mounting preventing keys which protrude from specified positions of an inner circumferential surface of the insertion port, separate from the socket surface, wherein a distance from the socket surface to the separate position is smaller than a distance from the front end surface of the cap protrusion to the attachment key, and in a state where the front end surface of the cap protrusion contacts, insertion of the cap protrusion into the insertion port is regulated, and rotation of the cap protrusion in the insertion port is possible in the regulated state, and when the cap protrusion is positioned at a specified mount position with respect to the socket body, the erroneous mounting preventing grooves of the cap protrusion are inserted through, and the cap protrusion can be inserted to a specified insertion position in the insertion port; and
an attachment groove which is provided on the inner circumferential surface of the insertion port and in which the attachment key of the cap protrusion inserted to the specified insertion position in the insertion port is inserted, and the cap is attached to the socket body through the attachment key.

2. The socket according to claim 1, wherein the inner circumferential surface of the insertion port is provided with the attachment groove between the plurality of erroneous mounting preventing keys.

3. The socket according to claim 1, wherein a size of the erroneous mounting preventing key in a direction corresponding to an axial direction of the insertion port is larger than a distance from the socket surface to the attachment key in a state where the front end surface of the cap protrusion contacts the erroneous mounting preventing key.

4. A lamp device mounted on the socket according to claim 1, comprising:
a housing including a cap;
a light source disposed in the housing; and
a lighting circuit to light the light source, wherein
the cap includes:
a cap body;
a cylindrical cap protrusion protruding from the cap body;
a plurality of erroneous mounting preventing grooves provided at specified positions of a tip peripheral part of the cap protrusion; and
an attachment key provided on an outer circumferential surface of the cap protrusion and protruding from a specified position separate from a front end surface of the cap protrusion.

5. A luminaire comprising:
an equipment device including the socket according to claim 1; and
a lamp device is mounted on the socket including
a housing including a cap;
a light source disposed in the housing; and
a lighting circuit to light the light source, wherein
the cap includes:
a cap body;
a cylindrical cap protrusion protruding from the cap body;
a plurality of erroneous mounting preventing grooves provided at specified positions of a tip peripheral part of the cap protrusion; and
an attachment key provided on an outer circumferential surface of the cap protrusion and protruding from a specified position separate from a front end surface of the cap protrusion.
